(19) United States
(12) Patent Application Publication
(10) Pub. No.: US 2004/0008170 A1
(43) Pub. Date: Jan. 15, 2004

(54) Liquid crystal display apparatus and driving method therefor

(75) Inventors: Tetsuya Makino, Kawasaki (JP); Toshiaki Yoshihara, Kawasaki (JP); Keiichi Betsui, Kawasaki (JP)

Correspondence Address: Patrick G. Burns, Esq., GREER, BURNS, & CRAIN, LTD., Suite 2500, 300 South Wacker Dr., Chicago, IL, 60606, US

(73) Assignee: FUJITSU LIMITED

(21) Appl. No.: 10/602,851

(22) Filed: Jun. 24, 2003

(30) Foreign Application Priority Data
Jun. 26, 2002 (JP) 2002-186841

(51) Int. Cl. G09G 3/36

(52) U.S. Cl. 345/87

(57) ABSTRACT

When a write polarity control signal PN is “L”, both of an odd-numbered output terminal and even-numbered output terminal apply a reset voltage as negative 0 gradation to the pixel electrode in the first half of the ON period, and apply a positive data voltage to the pixel electrode in the second half of the ON period. When the write polarity control signal PN is “H”, both of the odd-numbered output terminal and even-numbered output terminal apply a reset voltage as positive 0 gradation to the pixel electrode in the first half of the ON period, and apply a negative data voltage to the pixel electrode in the second half of the ON period. It is possible to write the data voltage for display to all pixels (the entire screen) always from a fixed state.

### BACKGROUND OF THE INVENTION

1. Field of the Invention

The present invention relates to a driving method for a liquid crystal display apparatus and to a liquid crystal display apparatus, and more particularly relates to a driving method for a liquid crystal display apparatus using a ferroelectric liquid crystal (FLC) or anti-ferroelectric liquid crystal (AFLC) having a spontaneous polarization and to the liquid crystal display apparatus.

2. Description of Related Art

The response speed of a widespread TN (Twisted Nematic) liquid crystal to an applied voltage is ten to several tens ms, and, in a region with low applied voltage, the response speed sometimes decreases abruptly to a value near a hundred ms. Accordingly, when displaying moving images (60 images/second) by a liquid crystal display apparatus using the TN liquid crystal, the liquid crystal molecules can not act sufficiently, and images are blurred. Thus, the TN liquid crystal is not suitable for use in applications involving display of moving images, such as multimedia.

Therefore, liquid crystal display apparatuses using a high-speed FLC or AFLC which can respond to an applied voltage at a high speed of several tens to several hundreds μs have been put into practical use. When these liquid crystals capable of responding at high speed are used in liquid crystal display apparatuses, moving images can be displayed excellently by controlling a voltage applied to each pixel with a switching element, such as a TFT (Thin Film Transistor) or MIM (Metal Insulator Metal), and completing the polarization of liquid crystal molecules in a short time.

A drive voltage for the FLC and AFLC is generally some ten V, and thus higher compared to the TN liquid crystal that can be driven at a low voltage ranging from 2 to 5 V. Moreover, in order to prevent deterioration of the liquid crystal and burning of a liquid crystal panel, it is necessary to drive the liquid crystal by an AC drive in which the polarity of a voltage applied to the liquid crystal is inverted every display period (frame or sub-frame). For example, when writing white display data by using a liquid crystal with a light transmission rate—applied voltage characteristic (hereinafter referred to as the T-V characteristic) as shown in FIG. 1A, it is necessary to write, to a pixel to which “−7.5 V” was written, “+7.5” in the next display period (the next frame or the next sub-frame). However, it is not certain whether the TFT has an ON-current characteristic sufficient to drive a liquid crystal drive voltage, and therefore, if the writing duration is short (for example, 5 μs), insufficient writing to the pixel electrode occurs, and it is difficult to apply a predetermined voltage to the liquid crystal. Thus, a voltage value applicable to the pixel varies depending on a pixel voltage value before the application of voltage, and there is a problem that a predetermined light transmission rate can not be obtained and an expected gradation display can not be achieved.

Furthermore, the TN liquid crystal generally has such a T-V characteristic that the light transmission rate is symmetrical with respect to the applied voltage polarity as shown in FIG. 1A; and whereas the FLC and AFLC have such a T-V characteristic that the light transmission rate has a single polarity with respect to the applied voltage polarity. Accordingly, when a dot inversion drive type source driver, which is a suitable measure to prevent flicker and has been popular for TN liquid crystal panels, is used for a liquid crystal display apparatus using an FLC or AFLC, the pixels to which a negative voltage is applied all display black, and thus there is a problem that a check-pattern black display is caused in each frame.

### BRIEF SUMMARY OF THE INVENTION

The present invention has been made with the aim of solving the above problems, and a main object of the present invention is to provide a driving method for a liquid crystal display apparatus and a liquid crystal display apparatus, capable of obtaining a predetermined light transmission rate by writing a data voltage for display to all pixels (the entire screen) always from a fixed state and thereby reducing the difference in applicable voltage values depending on a pixel voltage value before the application of the voltage.

Another object of the present invention is to provide a driving method for a liquid crystal display apparatus and a liquid crystal display apparatus, capable of preventing deterioration of a liquid crystal material and burning of a liquid crystal panel by driving the liquid crystal by an AC drive in which the polarity is inverted between the preceding and following display periods (frames or sub-frames).

Still another object of the present invention is to provide a driving method for a liquid crystal display apparatus and a liquid crystal display apparatus, capable of effectively utilizing the writing ability of a switching element in respective periods by arranging the first half period for refresh and the second half period for display within an ON period of the switching element to be substantially equal.

Yet another object of the present invention is to provide a driving method for a liquid crystal display apparatus and a liquid crystal display apparatus, capable of improving the refreshing efficiency by setting a reset voltage for refresh at 0 V when displaying moving images (including still images) in which the pixel transmission rate of pixels does not need to be changed since the absolute values of positive voltage and negative voltage applied to the pixels are substantially equal.

A further object of the present invention is to provide a driving method for a liquid crystal display apparatus and a liquid crystal display apparatus, capable of preventing a check-pattern black display even when a commercially available dot inversion drive type source driver is used for a liquid crystal panel using an FLC or AFLC having such a T-V characteristic that the light transmission rate has a single polarity with respect to the applied voltage polarity, by causing the voltages applied to pixel electrodes in each display period (frame or sub-frame) to have the same polarity.

A driving method for a liquid crystal display apparatus according to the first invention is a driving method for a liquid crystal display apparatus, including a substrate on which pixel electrodes and switching elements for on/off controlling voltage application to the pixel electrodes are arranged in matrix form; a substrate on which a counter electrode is provided; and a liquid crystal material having a spontaneous polarization sealed in a gap between the substrates, by applying a data voltage across the pixel electrodes and the counter electrode during an ON period of the switching elements and holding the data voltage during an OFF period so as to control a light transmission rate of the liquid crystal material which is determined by the data voltage, characterized in that the driving method applies a reset voltage of a constant value in a first half period of the ON period, and applies the data voltage in a second half period of the ON period.

A driving method for the liquid crystal display apparatus according to the second invention is based on the first invention, and characterized by on-off controlling the switching elements at predetermined time intervals so as to apply data voltages of opposite polarities alternately in preceding and following ON periods and apply a reset voltage with a polarity opposite to the data voltage in the same ON period.

A driving method for the liquid crystal display apparatus according to the third invention is based on the first and second inventions, and characterized in that the first half period is substantially ½ of the ON period.

A driving method for the liquid crystal display apparatus according to the fourth invention is based on the second and third inventions, and characterized in that the reset voltage is 0 V.

A liquid crystal display apparatus according to the fifth invention is a liquid crystal display apparatus including a substrate on which pixel electrodes and switching elements for on/off controlling voltage application to the pixel electrodes are arranged in matrix form; a substrate on which a counter electrode is provided; and a liquid crystal material having a spontaneous polarization sealed in a gap between the substrates, characterized in that a data voltage is applied across the pixel electrodes and the counter electrode during an ON period of the switching elements and the data voltage is held during an OFF period so as to control a light transmission rate of the liquid crystal material which is determined by the data voltage, the liquid crystal display apparatus comprising: means for applying a reset voltage of a predetermined value in a first half period of the ON period; and means for applying the data voltage in a second half period of the ON period.

A liquid crystal display apparatus according to the sixth invention is based on the fifth invention, and characterized in that the switching elements are on/off controlled at predetermined time intervals, the data voltage applied in an ON period has a polarity opposite to data voltages applied in ON periods preceding and following the ON period, and the reset voltage has a polarity opposite to the data voltage in the same ON period.

A liquid crystal display apparatus according to the seventh invention is based on the fifth and sixth inventions, and characterized in that the reset voltage is 0 V.

A liquid crystal display apparatus according to the eighth invention is based on the fifth and sixth inventions, and characterized in that the first half period is substantially ½ of the ON period.

A liquid crystal display apparatus according to the ninth invention is based on the fifth invention, and characterized by further comprising: a first scanning line connected with the switching elements connected to pixels in odd-numbered matrix columns among pixels in a matrix row, and a second scanning line connected with the switching elements connected to pixels in even-numbered matrix columns in the same matrix row; a first scanning circuit and second scanning circuit having a plurality of output portions for on/off controlling the switching elements; and a control circuit for controlling scanning of the first scanning circuit and second scanning circuit; wherein the first scanning line and second scanning line are connected to the output portions of the first scanning circuit and second scanning circuit, respectively, and the control circuit comprises: means for generating operation clock signals for determining scanning frequencies of the first scanning circuit and second scanning circuit so that polarities have a complementary relationship; and means for generating a common scanning start signal for determining scanning start timing of the first scanning circuit and second scanning circuit and the ON period.

A liquid crystal display apparatus according to the tenth invention is based on the fifth, sixth, seventh and eighth inventions, and characterized by further comprising: a first scanning line connected with the switching elements connected to pixels in odd-numbered matrix columns among pixels in a matrix row, and a second scanning line connected with the switching elements connected to pixels in even-numbered matrix columns in the same matrix row; and a scanning circuit having a plurality of output portions for on/off controlling the switching elements; wherein the first scanning line and the second scanning line are alternately connected to the output portions of the scanning circuit.

A liquid crystal display apparatus according to the eleventh invention is based on the tenth invention, and characterized by further comprising a control circuit for controlling scanning of the scanning circuit, wherein the scanning circuit comprises: means for generating an operation clock signal for determining a scanning frequency of the scanning circuit; and means for generating a scanning start signal, having a signal width equal to a two-clock period of the operation clock signal, for determining scanning start timing of the scanning circuit and the ON period.

In the driving method for the liquid crystal display apparatus of the first invention and the liquid crystal display apparatus of the fifth invention, since the reset voltage for refresh is applied prior to the application of the data voltage for display across the pixel electrodes and the counter electrode, the data voltage for display is always written to all pixels (the entire screen) from a fixed state, and therefore it is possible to reduce the difference in applicable voltage values depending on a pixel voltage value before the application of the voltage.

In the driving method for the liquid crystal display apparatus of the second invention and the liquid crystal display apparatus of the sixth invention, by driving the liquid crystal by an AC drive in which voltages of opposite polarities are applied to the liquid crystal in preceding and following display periods (frames or sub-frames), it is possible to prevent degradation of the liquid crystal material and burning of a liquid crystal panel.

In the driving method for the liquid crystal display apparatus of the third invention and the liquid crystal display apparatus of the eighth invention, by arranging the first half period for refresh and the second half period for display within the ON period of the switching elements to be substantially equal, it becomes possible to effectively utilize the writing ability of the switching elements in respective periods.

In the driving method for the liquid crystal display apparatus of the fourth invention and the liquid crystal display apparatus of the seventh invention, when displaying moving images (including still images) in which the light transmission rate of the pixels does not need to be changed, since the absolute values of positive voltage and negative voltage applied to the pixels are substantially equal, it is possible to improve the refreshing efficiency by setting the reset voltage for refresh at 0 V. In other words, by dividing the amount of charge supplied in the first half period for refresh and the amount of charge supplied in the second half period for display to be substantially ½ respectively, it becomes possible to effectively utilize the writing ability of the switching elements.

In the liquid crystal display apparatuses of the ninth and tenth inventions, by providing different scanning lines as a scanning line for a switching element that controls one pixel and a scanning line for a switching element that controls adjacent pixel, the switching elements of adjacent pixels can be on/off controlled separately.

In the liquid crystal display apparatus of the eleventh invention, by increasing the duration in which the reset voltage and the data voltage can be applied by two times, sufficient writing can be performed to the pixel electrodes. Moreover, during the ON period of the switching elements connected to the scanning lines in the preceding and following stages, by overlapping the second half period in which the data voltage for display is applied to the pixel connected to the scanning line in the preceding stage and the first half period in which the reset voltage for refresh is applied to the pixel connected to the scanning line in the following stage, it is possible to simultaneously apply desired voltages to the pixels connected to adjacent scanning lines and effectively utilize the writing ability of the switching elements.

The above and further objects and features of the invention will more fully be apparent from the following detailed description with accompanying drawings.

### BRIEF DESCRIPTION OF THE SEVERAL VIEWS OF THE DRAWINGS

FIG. 1A and FIG. 1B are graphs showing T-V characteristics of liquid crystal materials;

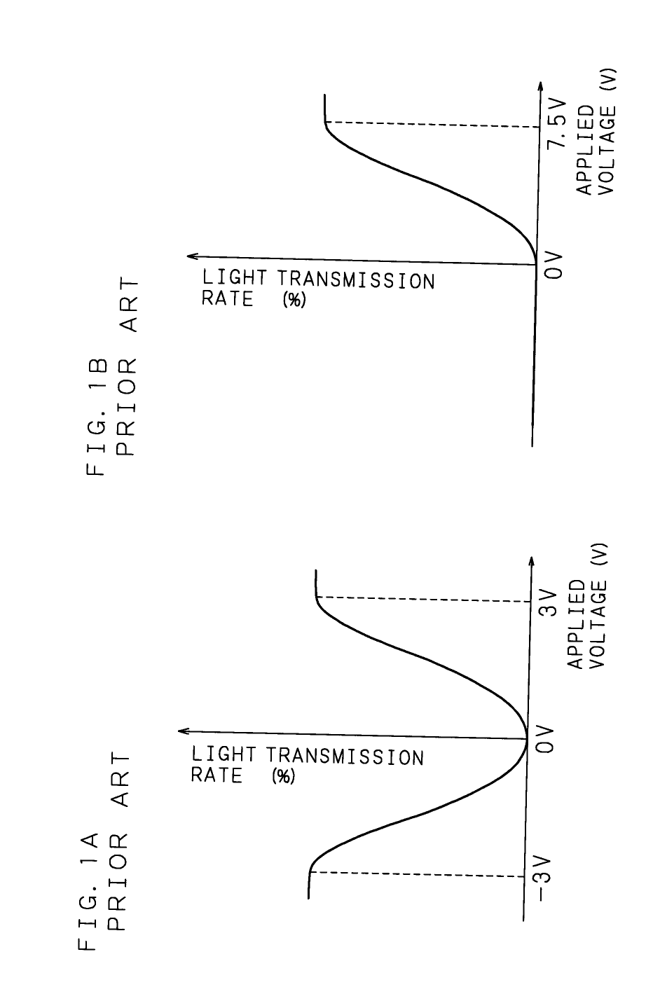

FIG. 2 is a schematic cross sectional view of a liquid crystal panel according to the present invention;

FIG. 3 is a schematic perspective view showing an example of the structure of the liquid crystal panel and back light according to the present invention;

FIG. 4 is a schematic plan view of a liquid crystal panel of a liquid crystal display apparatus according to the first embodiment of the present invention;

FIG. 5 is a block diagram showing the entire structure of the liquid crystal display apparatus according to the first embodiment of the present invention;

FIG. 6 is a block diagram showing the structure of a dot inversion drive type source driver;

FIG. 7 is a graph showing a gradation data-output voltage characteristic of the source driver;

FIG. 8 is a timing chart showing a drive sequence in the first embodiment of the present invention;

FIG. 9 is an illustration showing the voltage values applied to the pixel electrodes of the liquid crystal panel in the period t0 to t1 of FIG. 8;

FIG. 10 is an illustration showing the voltage values applied to the pixel electrodes of the liquid crystal panel in the period t1 to t2 of FIG. 8;

FIG. 11 is an illustration showing the voltage values applied to the pixel electrodes of the liquid crystal panel in the period t2 to t3 of FIG. 8;

FIG. 12 is an illustration showing the voltage values applied to the pixel electrodes of the liquid crystal panel in the period t3 to t4 of FIG. 8;

FIG. 13 is an illustration showing the polarities of pixel voltages in the first embodiment and the second embodiment of the present invention;

FIG. 14 is a schematic plan view of a liquid crystal panel of a liquid crystal display apparatus according to the second embodiment of the present invention;

FIG. 15 is a block diagram showing the entire structure of the liquid crystal display apparatus according to the second embodiment of the present invention;

FIG. 16 is an illustration showing a drive sequence in the second embodiment of the present invention;

FIG. 17 is an illustration showing the voltage values applied to the pixel electrodes of the liquid crystal panel in the period t0 to t1 of FIG. 16;

FIG. 18 is an illustration showing the voltage values applied to the pixel electrodes of the liquid crystal panel in the period t1 to t2 of FIG. 16;

FIG. 19 is an illustration showing the voltage values applied to the pixel electrodes of the liquid crystal panel in the period t2 to t3 of FIG. 16; and

FIG. 20 is an illustration showing the voltage values applied to the pixel electrodes of the liquid crystal panel in the period t3 to t4 of FIG. 16.

### DETAILED DESCRIPTION OF THE PREFERRED EMBODIMENTS

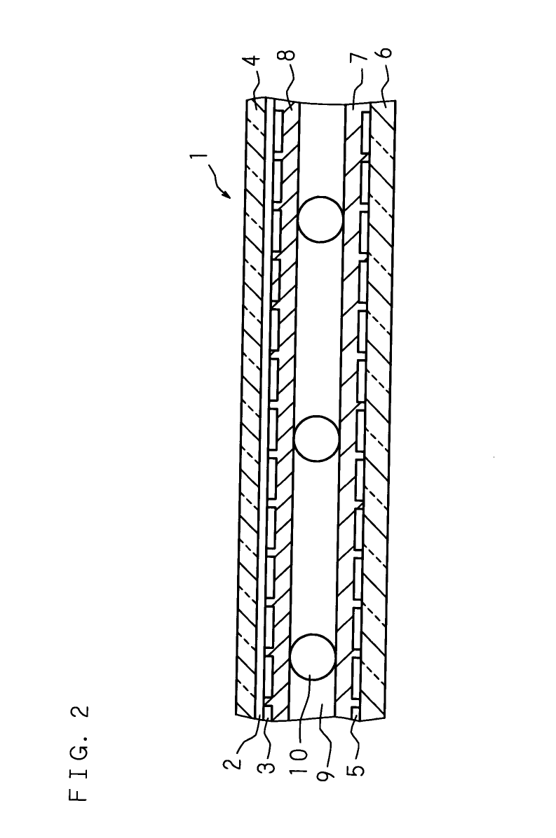

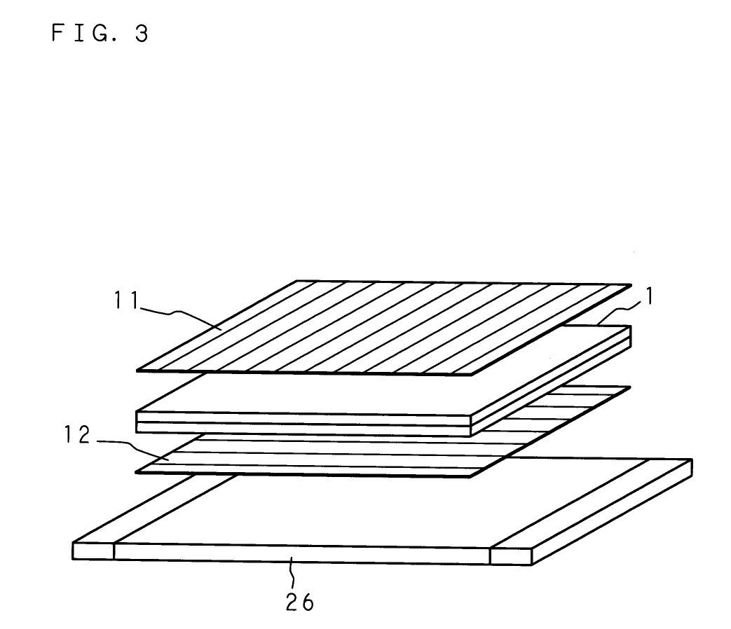

The following description will explain the present invention in detail, based on the drawings illustrating some embodiments thereof. FIG. 2 is a schematic cross sectional view of a liquid crystal panel according to the present invention, and FIG. 3 is a schematic perspective view showing an example of the structure of the liquid crystal panel and back light.

(First Embodiment)

As shown in FIG. 2, a liquid crystal panel 1 comprises a glass substrate 6 on which pixels electrodes 5 ((0.24×0.24)(mm²), number of pixels: 1024 H×768 V, diagonal: 12.1 inches) made of ITO (indium Tin Oxide) with a high light transmission rate and TFTs connected to the pixel electrodes 5, respectively, are arranged in matrix form; and a glass substrate 4 having a counter electrode 2 and color filters 3 arranged in matrix form. Alignment films 7 and 8 are provided on the pixel electrodes 5 and the color filters 3, respectively. The glass substrate 6 and the glass substrate 4 are arranged so that the alignment films 7 and 8 face each other. Spherical spacers 10 are spread to keep a uniform gap (1.6 μm) in a plane between the alignment films 7 and 8, thereby forming a gap. By filling the gap with an FLC, a liquid crystal layer 9 is formed. As shown in FIG. 3, this liquid crystal panel 1 is sandwiched between two polarizing plates 11 and 12, and further a back light 26 is provided under the liquid crystal panel 1.

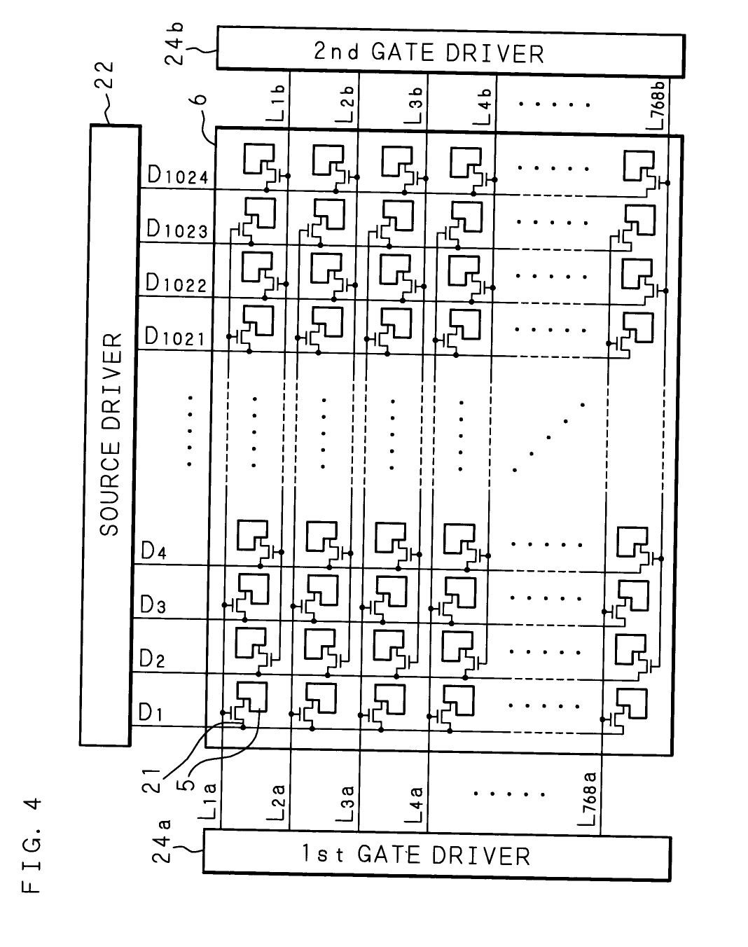

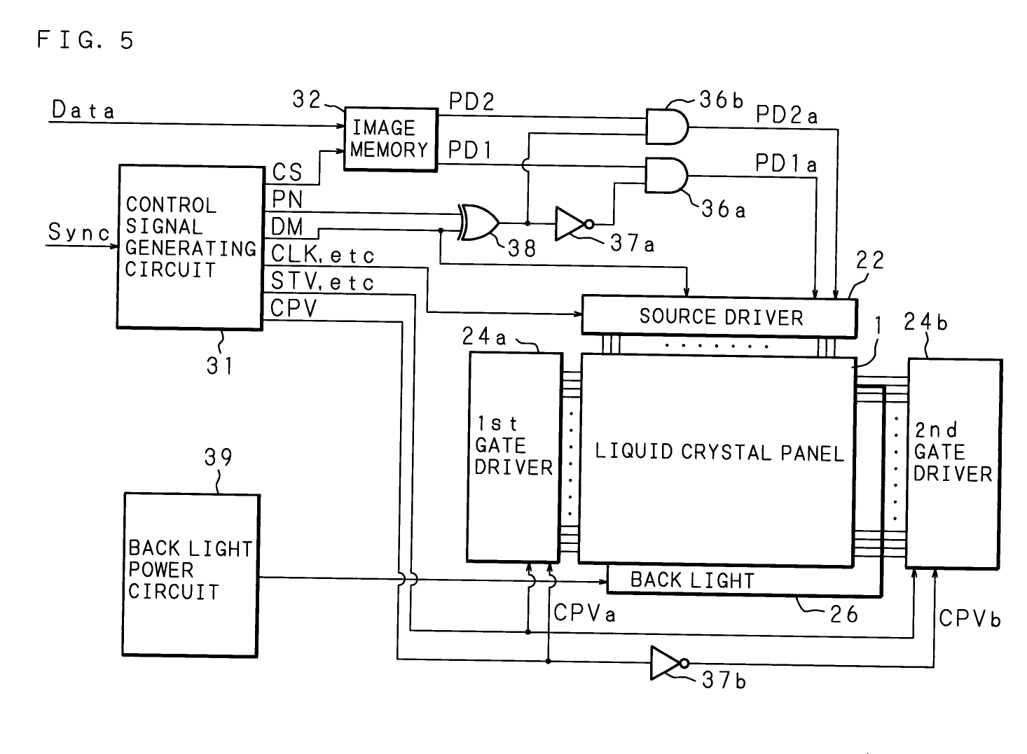

FIG. 4 is a schematic plan view of the liquid crystal panel of a liquid crystal display apparatus according to the first embodiment of the present invention, and FIG. 5 is a block diagram of the entire liquid crystal display apparatus. As shown in FIG. 4, the pixel electrodes 5 and the TFTs 21 are arranged in matrix (1024 H×768 V) on the glass substrate 6, and the pixel electrodes 5 are connected to the drain terminals of the TFTs 21, respectively. The gate terminals of the TFTs 21 in the odd-numbered columns in the i-th (i=1, 2, 3, . . . , 768) row and the gate terminals of the TFTs 21 in the even-numbered columns in the i-th row are connected to a first scanning line Lᵢₐ and a second scanning line L_{ib}, respectively, while the source terminals of the TFTs 21 in the j-th column (j=1, 2, 3, . . . , 1024) are connected to a data line Dⱼ. The first scanning lines Lᵢₐ and second scanning lines L_{ib} are sequentially connected to the output stages of the first gate driver 24a and second gate driver 24b, respectively, while the data lines Dⱼ are sequentially connected to the output stages of the source driver 22.

Note that, although any DC voltage can be applied to the counter electrode 2, it is supposed, to simplify the following explanation, that 0V voltage is applied to the counter electrode 2 and a voltage applied to the pixel electrodes 5 is the voltage between the pixel electrodes 5 and the counter electrode 2 that controls the light transmission rate of the pixels.

The TFTs 21 in the odd-numbered columns are on/off controlled by inputting scanning signals, which are supplied line sequentially from the first gate driver 24a, to the first scanning lines Lᵢₐ, and apply a data voltage inputted to each data line Dⱼ from the source driver 22 to the pixel electrodes 5 during the ON period, while hold the previously applied voltage during the OFF period. Similarly, the TFTs 21 in the even-numbered columns are on/off controlled by inputting scanning signals, which are supplied line sequentially from the second gate driver 24b, to the second scanning lines L_{ib}, and apply a data voltage inputted to each data line Dⱼ from the source driver 22 to the pixel electrodes 5 during the ON period, while hold the previously applied voltage during the OFF period. Then, by controlling the light transmission rate of the liquid crystal which is determined by the T-V characteristic as an electro-optical characteristic of the liquid crystal, based on the data voltage applied through the TFTs 21, an image is displayed.

The liquid crystal display apparatus of this embodiment comprises peripheral circuits, such as a control signal generating circuit 31, an image memory 32, a first logical product circuit (AND circuit) 36a, a second logical product circuit (AND circuit) 36b, a first inverting circuit (INV circuit) 37a, a second inverting circuit (INV circuit) 37b, an exclusive OR circuit (EX-OR circuit) 38 and a back-light power circuit 39, as shown in FIG. 5, in addition to the above-mentioned source driver 22, first gate driver 24a and second gate driver 24b.

The control signal generating circuit 31 generates, from an inputted synchronous signal Sync, an image control signal CS for controlling an output timing of an image signal stored in the image memory 32, a write polarity control signal PN for controlling a voltage polarity for writing a data voltage to the pixel electrode 5, an output polarity control signal DM for controlling an output voltage polarity of the source driver 22, a clock signal CLK, etc. for controlling the operation of the source driver 22, an operation clock signal CPV for determining a common scanning frequency for controlling the operations of the first gate driver 24a and the second gate driver 24b, and a scanning start signal STV, etc. for determining scanning start timing, etc. Further, the control signal generating circuit 31 outputs the generated image control signal CS to the image memory 32; outputs the write polarity control signal PN to the exclusive OR circuit 38; outputs the output polarity control signal DM to the exclusive OR circuit 38 and the source driver 22; outputs the clock signal CLK, etc. to the source driver 22; outputs the operation clock signal CPV to the first gate driver 24a and the second inverting circuit 37b; and outputs the scanning start signal STV, etc. to the first gate driver 24a and the second gate driver 24b.

The image memory 32 temporarily stores display data Data to be displayed on the liquid crystal panel 1, and outputs data PD1 for displaying odd-numbered columns to the first AND circuit 36a and data PD2 for displaying even-numbered columns to the second AND circuit 36b alternately in synchronous with the image control signal CS generated by the control signal generating circuit 31.

The exclusive OR circuit 38 is supplied with the write polarity control signal PN and output polarity control signal DM both generated by the control signal generating circuit 31, and outputs exclusive OR signal of these two signals. The output signal of the exclusive OR circuit 38 functions as an output selection signal for determining whether a data voltage for display or a reset voltage for refresh is to be applied to the pixel electrode 5.

The first AND circuit 36a is a circuit for generating data signals for display and data signals for refresh for odd-numbered columns. More specifically, the first AND circuit 36a generates an AND signal PD1a from a signal obtained by inverting the output selection signal generated by the exclusive OR circuit 38 in the first inverting circuit 37a and the data PD1 for display of odd-numbered columns read from the image memory 32, and inputs this signal PD1a as the data signal DATA to the source driver 22.

The following description explains in further detail the operation of the first AND circuit 36a when the data for display is 8-bit data. The AND signals of inputted bits (din 1, din 2, . . . , din 8) and the inverted signal of the output selection signal generated by the exclusive OR circuit 38 are outputted as data bits (dout 1, dout 2, . . . , dout 8) of the data signal DATA. Consequently, the data bits (dout 1, dout 2, . . . , dout 8) outputted from the first AND circuit 36a become 0 gradation data (L, L, . . . , L) when the output selection signal is “H”, or become the data for display (din 1, din 2, . . . , din 8) when the output selection signal is “L”.

The second AND circuit 36b is a circuit for generating data signals for display and data signals for refresh for even-numbered columns. More specifically, the second AND circuit 36b generates an AND signal PD2a from the output selection signal generated by the exclusive OR circuit 38 and the data PD2 for display of even-numbered columns read from the image memory 32, and inputs this signal PD2a as the data signal DATA to the source driver 22.

The following description explains in further detail the operation of the second AND circuit 36b when the display data is 8-bit data. The AND signals of inputted bits (din 1, din 2, . . . , din 8) and the output selection signal generated by the exclusive OR circuit 38 are outputted as data bits (dout 1, dout 2, . . . , dout 8) of the data signal DATA. Consequently, the data bits (dout 1, dout 2, . . . , dout 8) outputted from the second AND circuit 36b become 0 gradation data (L, L, . . . , L) when the output selection signal is “L”, or become the data for display (din 1, din 2, . . . , din 8) when the output selection signal is “H”.

The scanning start signal STV generated by the control signal generating circuit 31 is inputted to the first gate driver 24a and the second gate driver 24b. Meanwhile, the operation clock signal CPV is inputted as it is, as an operation clock signal CPVa, to the first gate driver 24a, and a signal inverted by the second inverting circuit 37b (the inverted signal of CPV) is inputted as an operation clock signal CPVb to the second gate driver 24b.

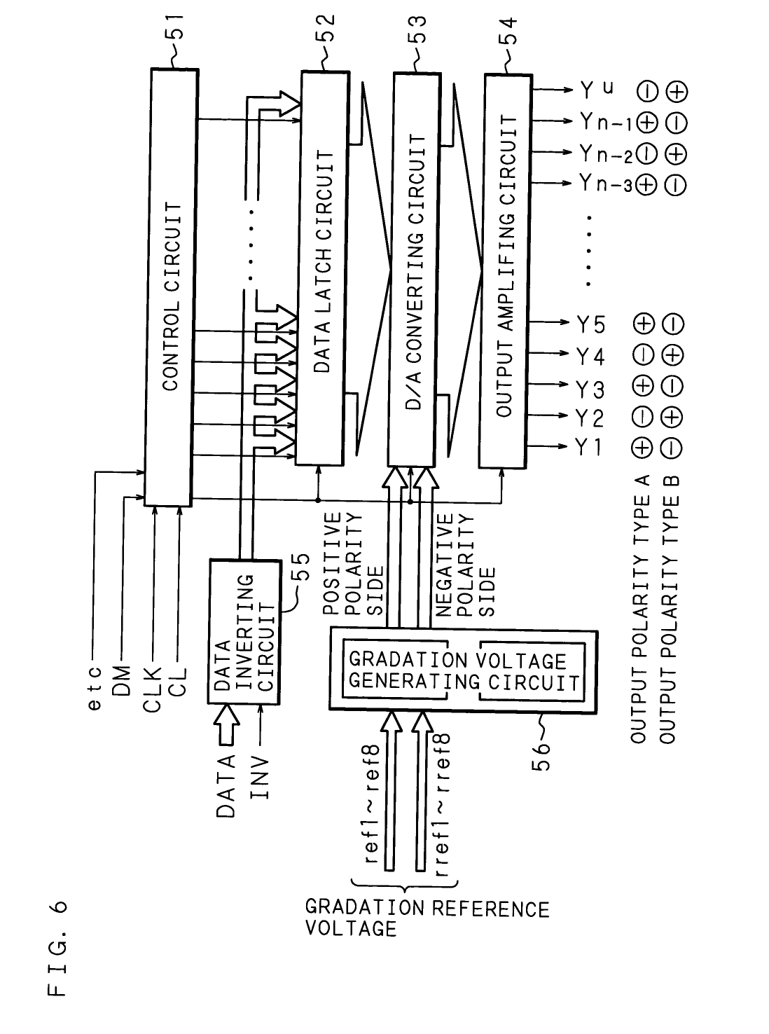

The operation of the source driver 22 as a dot inversion drive type source driver will be described in detail. FIG. 6 is a block diagram showing the structure of the dot inversion drive type source driver. The source driver comprises a control circuit 51, a data latch circuit 52, a D/A converting circuit 53, an output amplifying circuit 54, a data inverting circuit 55, and a gradation voltage generating circuit 56.

The control circuit 51 generates a later-described signal for determining data latch timing of the data signal from the clock signal CLK, output polarity control signal DM, control signal CL, etc. inputted from outside, and outputs the generated signal to the data latch circuit 52. In addition, the control circuit 51 outputs signals for controlling the operations of the data latch circuit 52, D/A converting circuit 53, and output amplifying circuit 54. The data inverting circuit 55 inputs a signal generated from the inputted data signal DATA and data inverted signal INV for controlling inversion/non-inversion of the data signal DATA to the data latch circuit 52 in synchronism with the clock signal CLK. The data latch circuit 52 transfers the data signal DATA stored in the data latch circuit 52 to the D/A converting circuit 53 at the time of rising of the control signal CL. The gradation voltage generating circuit 56 generates a positive gradation electric potential (256-gradation) and a negative gradation electric potential (256-gradtion) from gradation reference voltages (in the case of 8 bits: positive side ref 1 to ref 8, negative side ref 1 to ref 8) inputted from outside, and inputs these positive gradation electric potential and negative gradation electric potential to the D/A converting circuit 53. The D/A converting circuit 53 transfers a positive voltage or a negative voltage, which was obtained by converting the data signal DATA into an analog signal based on the information of the output polarity control signal DM, to the output amplifying circuit 54 at the time of falling of the control signal CL.

The relationship between the output polarity control signal DM and the output voltage is as shown in Table 1. When the output polarity control signal DM is “L”, a positive voltage is outputted from an odd-numbered output terminal, and a negative voltage is outputted from an even-numbered output terminal (output polarity type A). On the other hand, when the output polarity control signal DM is “H”, a negative voltage is outputted from the odd-numbered output terminal, and a positive voltage is outputted from the even-numbered output terminal (output polarity type B).

TABLE 1

| | Odd-numbered | Even-numbered |
|---|---|---|
| DM signal | output terminal | output terminal |
| L | Positive voltage | Negative voltage |
| H | Negative voltage | Positive voltage |

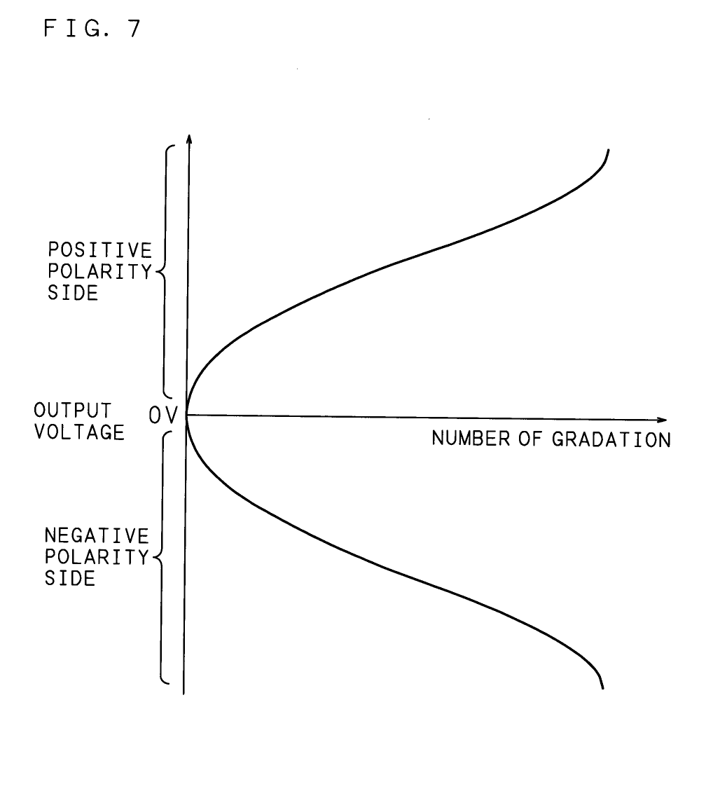

FIG. 7 is a graph showing a gradation data-output voltage characteristic of the source driver 22. When 0 gradation data is inputted, the output voltage is 0 V, and the output voltage is described as “+0 V” or “−0 V” to distinguish whether the 0 gradation data passed through a positive polarity side circuit or a negative polarity side circuit of the gradation voltage generating circuit 56.

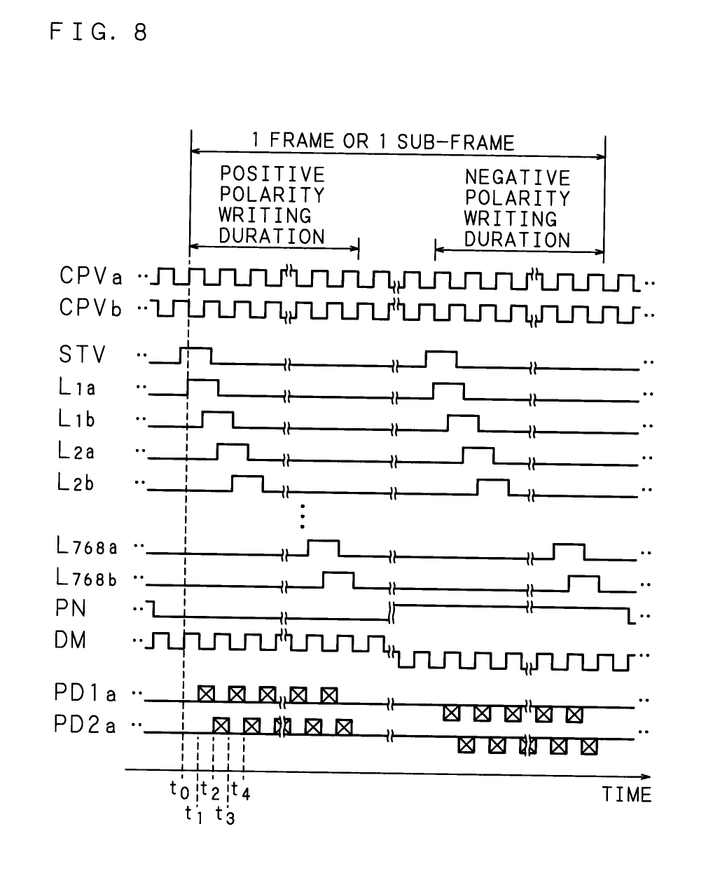

FIG. 8 is a timing chart showing a drive sequence in the first embodiment of the present invention. First, the following description will explain the timing of the first scanning line Lᵢₐ and the second scanning line L_{ib}. CPVa is an operation clock signal of the first gate driver 24a for scanning the TFTs 21 in the odd-numbered columns. CPVb is an operation clock signal of the second gate driver 24b for scanning the TFTs 21 in the even-numbered columns. The CPVa and CPVb have such a relationship that they have equal frequency and opposite polarities. STV is a common scanning start signal of the first gate driver 24a and second gate driver 24b. The width of the “H” period of STV that determines the ON period of the TFT 21 is substantially equal to one clock of the operation clock signals CPVa and CPVb, and the STV is inputted substantially ¼ clock prior to the rise of the operation clock signal CPVa so as to prevent a latching mistake of the first gate driver 24a and second gate driver 24b.

Each of the first gate driver 24a and second gate driver 24b includes a shift register therein. The output stages of the first gate driver 24a and second gate driver 24b obtain voltage values of the input signals at the rising edges of the operation clock signals CPVa and CPVb, respectively, and hold the obtained voltage values at time other than the rising edges. In the gate drivers 24a and 24b, the held voltage values are delayed for a predetermined time to make input signals for the next stage. Thus, based on the scanning start signal STV and the operation clock signals CPVa and CPVb, signals for sequentially scanning the ON periods (“H” periods) are inputted to the first scanning lines Lᵢₐ and the second scanning lines L_{ib}.

If an edge where the operation clock signal CPVa rises when the scanning start signal STV is in the “H” state is considered as the first rising edge, a signal to be inputted to the first scanning line Lᵢₐ connected to the output stage of the first gate driver 24a rises at the i-th rising edge of the operation clock signal CPVa, and falls at the (i+1)th rising edge of the same. Similarly, if an edge where the operation clock signal CPVb rises when the scanning start signal STV is in the “H” state is considered as the first rising edge, a signal to be inputted to the second scanning line L_{ib} connected to the output stage of the second gate driver 24b rises at the i-th rising edge of the operation clock signal CPVb, and falls at the (i+1)th rising edge of the same. For example, the first scanning line L₁ₐ rises at the first rising edge of the operation clock signal CPVa, and falls at the second rising edge of the operation clock signal CPVa. The second scanning line L_{1b} rises at the first rising edge of the operation clock signal CPVb, and falls at the second rising edge of the operation clock signal CPVb. The first scanning line L₂ₐ rises at the second rising edge of the operation clock signal CPVa, and falls at the third rising edge of the operation clock signal CPVa. The second scanning line L_{2b} rises at the second rising edge of the operation clock signal CPVb, and falls at the third rising edge of the operation clock signal CPVb.

Therefore, as the scanning line for scanning one row of the TFTs 21 arranged in matrix form, by providing the first scanning line Lᵢₐ for odd-numbered columns and the second scanning line L_{ib} for even-numbered columns, the period of turning on the TFT 21 can be made different between the TFTs 21 in the odd-numbered columns and the TFTs 21 in the even-numbered columns in the same row. However, although an overlapped time is present between them, since display gradation is determined by a voltage applied to the pixel through the TFT 21 at the end of the ON period, it is important that the ON periods end at different timings.

Next, the timing of the data scanning lines Dⱼ will be explained. A write polarity control signal PN of “L” is inputted in a positive polarity writing duration, while a write polarity control signal PN of “H” is inputted in a negative polarity writing duration. The output polarity control signal DM is a signal with the same frequency as the operation clock signals CPVa and CPVb of the first gate driver 24a and second gate driver 24b. The inverted signal of the exclusive OR of the write polarity control signal PN and the output polarity control signal DM is a signal for selecting a write voltage for an odd-numbered column either as a reset voltage for refresh or a data voltage for display. The exclusive OR signal of the write polarity control signal PN and the output polarity control signal DM is a signal for selecting a write voltage for an even-numbered column either as a reset voltage for refresh or a data voltage for display.

The relationship between the combination of the polarities of the write polarity control signal PN and output polarity control signal DM and the output voltage is as shown in Table 2. For example, when the write polarity control signal PN is “L” and the output polarity control signal DM is “L”, a positive data voltage is outputted from an odd-numbered output terminal, and a negative 0 gradation voltage (−0 V) as a reset voltage is outputted from an even-numbered output terminal.

TABLE 2

| PN | DM | Odd-numbered | Even-numbered |
|---|---|---|---|
| signal | signal | output terminal | output terminal |
| L | L | Positive data voltage | Negative 0 gradation |
| | | | voltage (−0 V) |
| L | H | Negative 0 gradation | Positive data voltage |
| | | voltage (−0 V) | |
| H | L | Positive 0 gradation | Negative data voltage |
| | | voltage (+0 V) | |
| H | H | Negative data voltage | Positive 0 gradation |
| | | | voltage (+0 V) |

Accordingly, during an ON period of the TFT 21, the reset voltage for refreshing is applied to the pixel electrode 5 in the first half of the ON period, while the data voltage for display is applied to the pixel electrode 5 in the second half of the ON period. More specifically, when the write polarity control signal PN is “U”, both of the odd-numbered output terminal and even-numbered output terminal apply a reset voltage (−0 V) as negative 0 gradation to the pixel electrodes 5 in the first half of the ON period, and apply a positive data voltage to the pixel electrodes 5 in the second half of the ON period. When the write polarity control signal PN is “H”, both of the odd-numbered output terminal and even-numbered output terminal apply a reset voltage (+0 V) as positive 0 gradation to the pixel electrodes 5 in the first half of the ON period, and apply a negative data voltage to the pixel electrodes 5 in the second half of the ON period. Note that by adjusting the duty ratio of the operation clock signals CPVa and CPVb to be substantially 50%, the first half of the ON period and the second half of the ON period can be made substantially equal to each other.

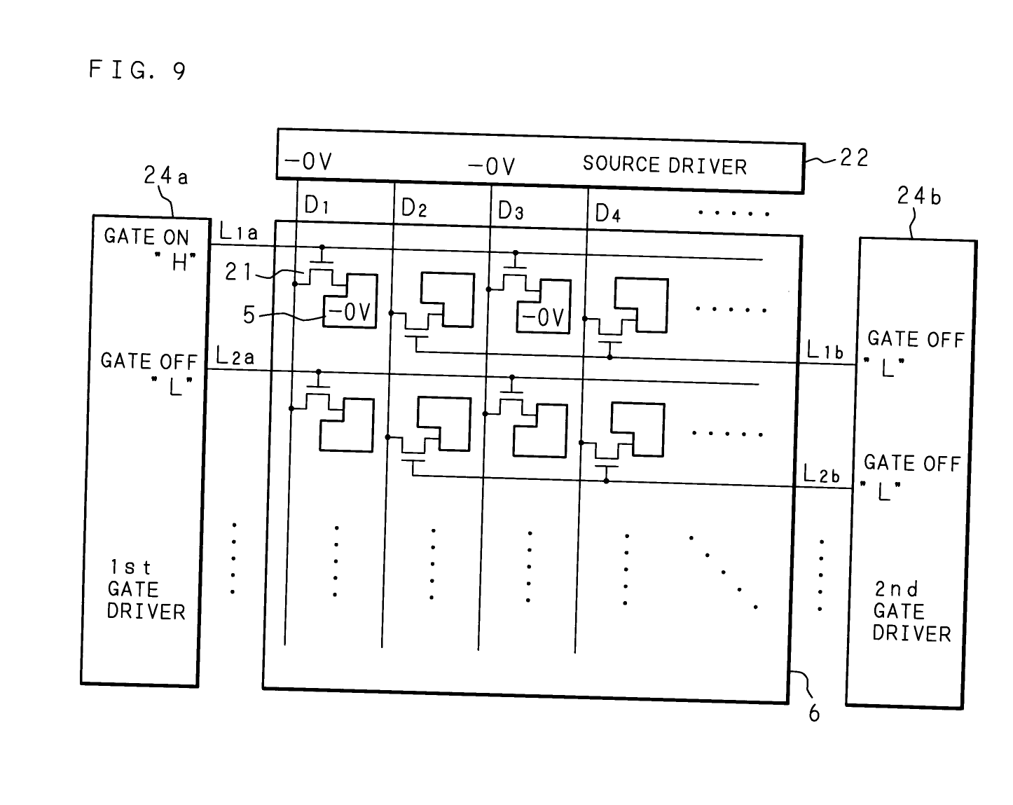

FIG. 9 through FIG. 12 show voltages applied to the pixels in the periods from t0 to t4 of the timing chart of FIG. 8. In the period t0 to t1, since the “H” signal is inputted to the first scanning line L₁ₐ, the TFTs 21 in the odd-numbered columns in the first row, connected to the first scanning line L₁ₐ, are turned ON. Consequently, the reset voltage (−0 V) as negative 0 gradation supplied to the respective data lines Dⱼ is supplied to the pixel electrodes 5 (See FIG. 9).

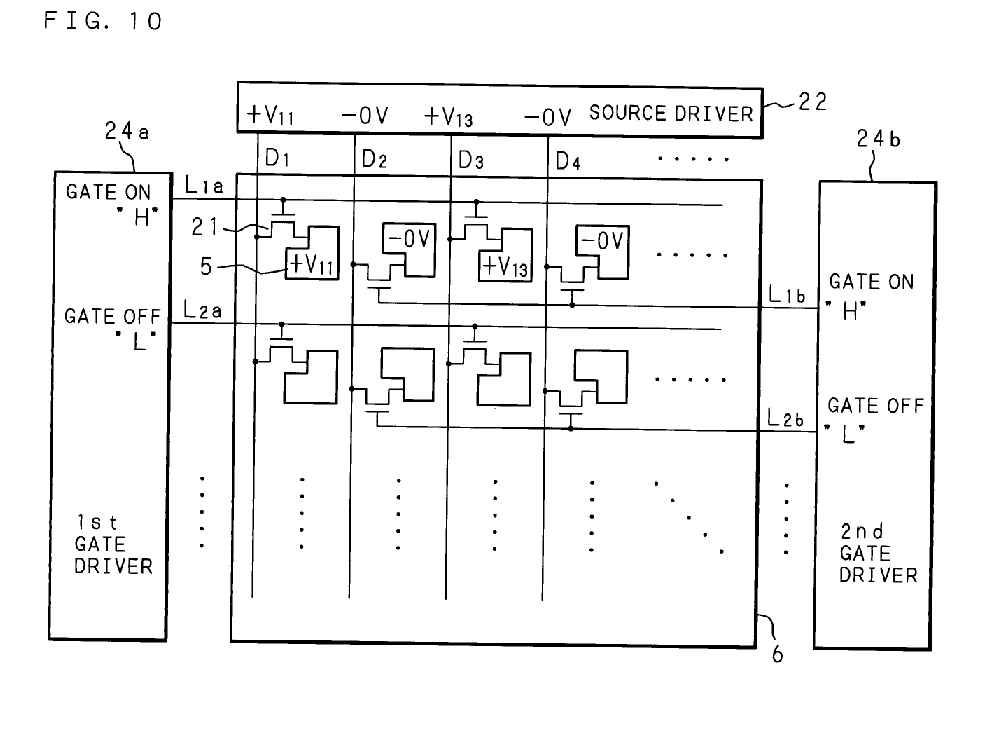

In the period t1 to t2, since the “H” signal is inputted to the first scanning line L₁ₐ and the second scanning line L_{1b}, the TFTs 21 in the odd-numbered columns in the first row, connected to the first scanning line L₁ₐ, hold the ON state, and the positive data voltages (+V11, +V13, . . . ) supplied to the respective data lines Dⱼ are supplied to the pixel electrodes 5, and then the TFTs 21 in the even-numbered columns in the first row, connected to the second scanning line L_{1b}, are turned ON. Consequently, the reset voltage (−0 V) as negative 0 gradation supplied to the respective data lines Dⱼ is supplied to the pixel electrodes 5 (See FIG. 10).

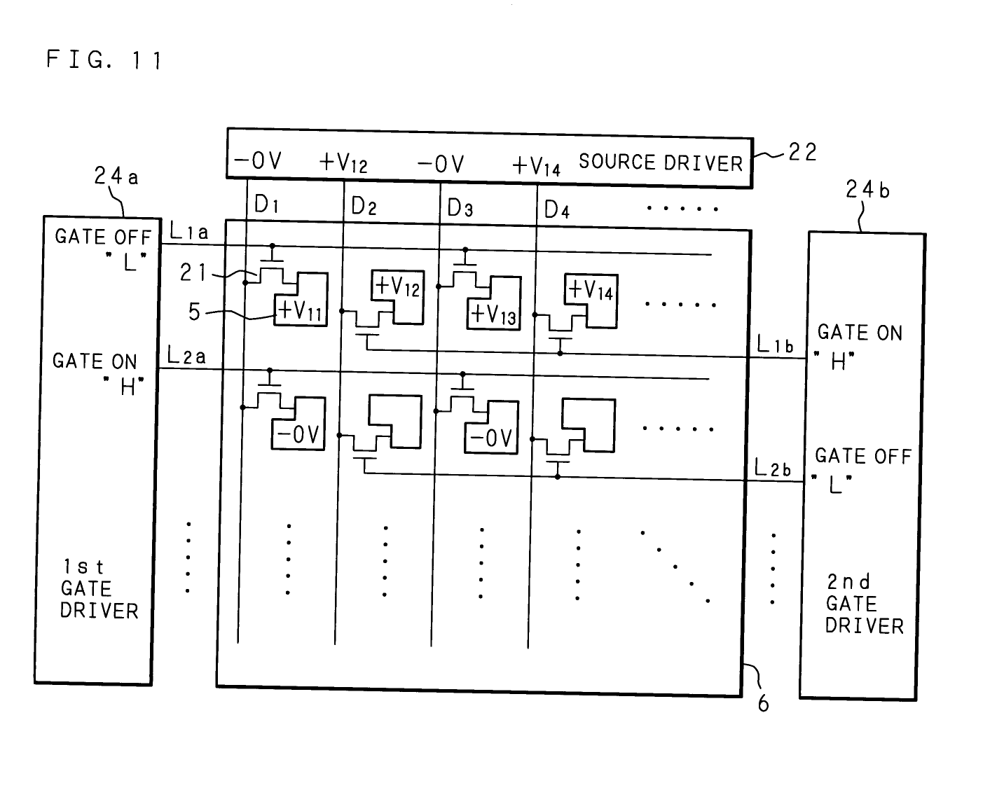

In the period t2 to t3, since the “L” signal is inputted to the first scanning line L₁ₐ, the TFTs 21 in the odd-numbered columns in the first row, connected to the first scanning line L₁ₐ, are turned OFF, and hold the positive data voltages (+V11, +V13, . . . ) supplied in the previous period (the t1 to t2 period). Besides, since the “H” signal is inputted to the first scanning line L_{1b} and the second scanning line L₂ₐ, the TFTs 21 in the even-numbered columns in the first row, connected to the second scanning line L_{1b}, hold the ON state, and the positive data voltages (+V12, +V14, . . . ) supplied to the respective data lines Dⱼ are supplied to the pixel electrodes 5, and then the TFTs 21 in the odd-numbered columns in the second row, connected to the first scanning line L₂ₐ, are turned ON. Consequently, the reset voltage (−0 V) as negative 0 gradation supplied to the respective data lines Dⱼ is supplied to the pixel electrodes 5 (Se FIG. 11).

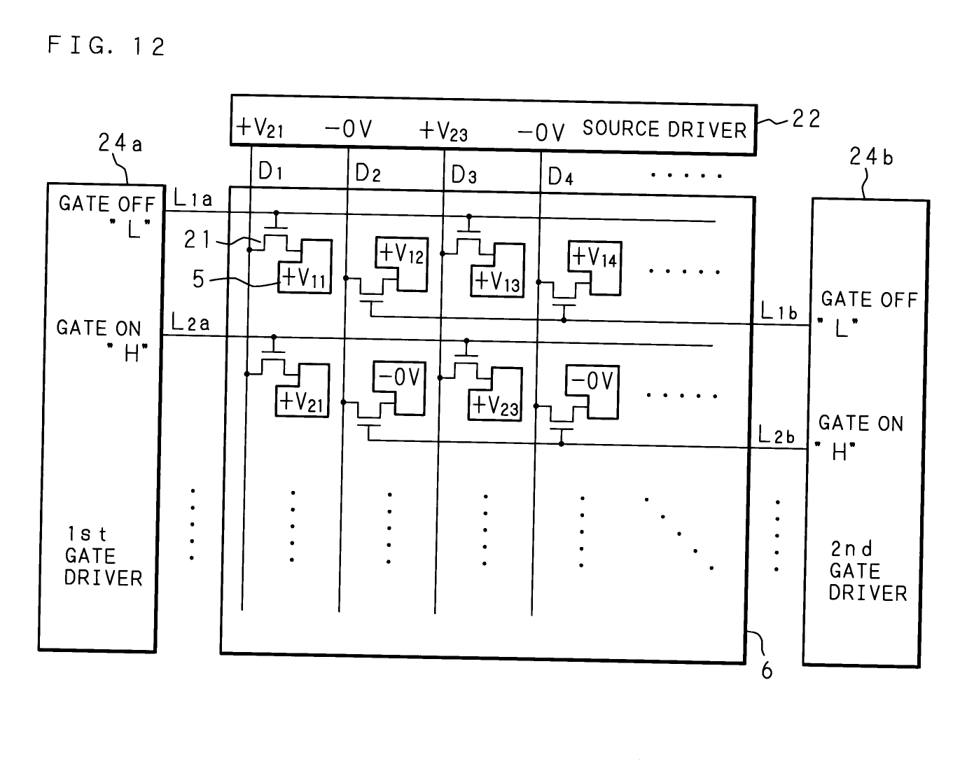

In the period t3 to t4, since the “L” signal is inputted to the second scanning line L_{1b}, the TFTs 21 in the even-numbered columns in the first row, connected to the second scanning line L_{1b}, are turned OFF and hold the positive data voltages (+V12, +V14, . . . ) supplied in the previous period (the t2 to t3 period). Besides, since the “H” signal is inputted to the first scanning line L₂ₐ and the second scanning line L_{2b}, the TFTs 21 in the odd-numbered columns in the second row, connected to the first scanning line L₂ₐ, hold the ON state, and the positive data voltages (+V21, +V23, . . . ) supplied to the respective data lines Dⱼ are supplied to the pixel electrodes 5, and then the TFTs 21 in the even-numbered columns in the second row, connected to the second scanning line L_{2b}, are turned ON. Consequently, the reset voltage (−0 V) as negative 0 gradation supplied to the respective data lines Dⱼ is supplied to the pixel electrodes 5 (See FIG. 12).

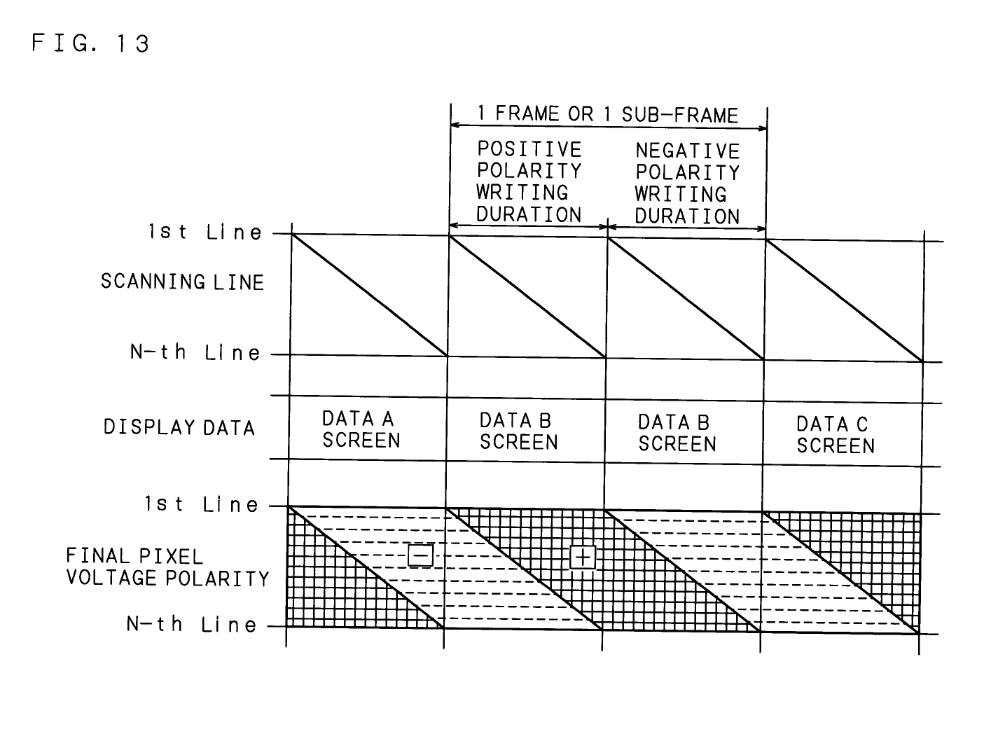

With this sequence of operations, since the reset voltage is applied just before the application of the data voltage, it is possible to apply a predetermined data voltage without depending on the data voltage of the previous frame. Moreover, the voltage polarities applied to the respective pixels have the polarities as shown in FIG. 13, and thus it is possible to display the same polarity.

More specifically, in one frame, all the voltages applied to the respective pixel electrodes 5 are either a positive voltage or a negative voltage, and a data voltage for display is applied to each pixel electrode 5 during the application of a positive voltage, while a voltage of the opposite polarity for preventing burning of the liquid crystal panel and deterioration of the liquid crystal molecules is applied to each pixel electrode 5 during the application of a negative voltage.

Here, the following description will explain a method for manufacturing the liquid crystal panel shown in FIG. 2 and FIG. 3. After cleaning the glass substrate 6 having the pixel electrodes 5 ((0.24×0.24)(mm²), number of pixels: 1024 H×768 V, diagonal: 12.1 inches) made of an ITO film, and the glass substrate 4 having the color filter 3 of three colors, RGB, and the counter electrode 2, they are coated with polyamide and then baked for one hour at 200° C. so as to form about 2000 nm polyamide films as the alignment films 7 and 8.

Surfaces of these alignment films 7 and 8 are rubbed with a rayon fabric, and then an empty panel is manufactured by stacking the two alignment films 7 and 8 with a gap being maintained therebetween by the spacers 10 made of silica having an average particle size of 1.6 μm. An FLC composed mainly of a naphthalene-based liquid crystal is sealed in this empty panel to form the liquid crystal layer 9.

The liquid crystal panel 1 is obtained by sandwiching the manufactured panel by two polarizing plats 11 and 12 arranged in a crossed-Nicol state so that a dark state is produced when the long axis direction of the liquid crystal molecule of the FLC is tilted in one direction. A liquid crystal display apparatus is manufactured by positioning a back light 26 so that the light of the back light 26 enters from the rear face of this liquid crystal panel 1.

(Second Embodiment)

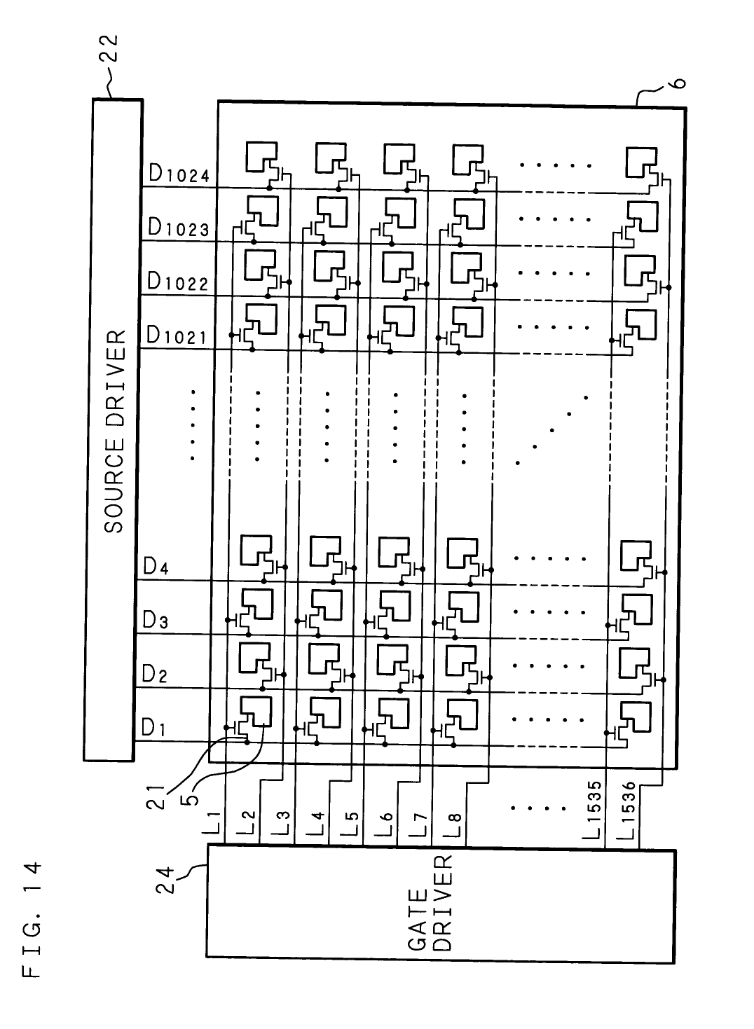

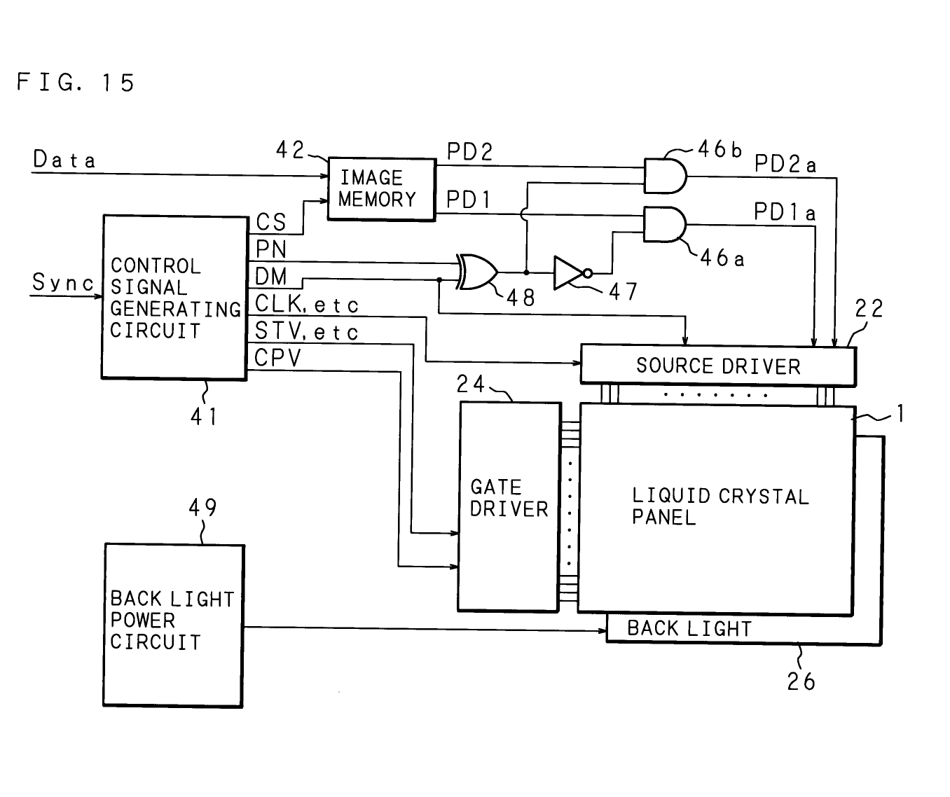

In the first embodiment, two gate drivers are used to scan the first scanning lines and second scanning lines, respectively. However, a single gate driver may be used to scan the first scanning lines and second scanning lines, and such a structure is illustrated as the second embodiment. FIG. 14 is a schematic plan view of the liquid crystal panel of a liquid crystal display apparatus according to the second embodiment of the present invention, and FIG. 15 is a block diagram showing the entire structure of the liquid crystal display apparatus.

As shown in FIG. 14, the pixels electrodes 5 and the TFTs 21 are arranged in matrix (1024 H×768 V) on the glass substrate 6, and the pixel electrodes 5 are connected to the drain terminals of the TFTs 21, respectively. The gate terminals of the TFTs 21 in the odd-numbered columns in the i-th (i=1, 2, 3, . . . , 768) row and the gate terminals of the TFTs 21 in the even-numbered columns in the i-th row are connected to a scanning line L₂ᵢ₋₁ and a scanning line L₂ᵢ (hereinafter referred to as the scanning lines Lₖ (k=1, 2, 3, . . . , 1536)), respectively, while the source terminals of the TFTs 21 in the j-th column (j=1, 2, 3, . . . , 1024) are connected to a data line Dⱼ. The first scanning lines Lₖ are sequentially connected to the output stages of the gate driver 24, while the data lines Dⱼ are sequentially connected to the output stages of the source driver 22.

Note that although any DC voltage can be applied to the counter electrode 2, it is supposed, to simplify the following explanation, that 0V voltage is applied to the counter electrode 2. It is also supposed that the voltage applied to the pixel electrode 5 is a voltage between the pixel electrodes 5 and the counter electrode 2 that controls the light transmission rate of the pixels.

The TFTs 21 are on/off controlled by inputting scanning signals, which are supplied line sequentially from the gate driver 24, to the scanning lines Lₖ. The TFTs 21 apply a data voltage inputted to each data line Dⱼ from the source driver 22 to the pixel electrodes 5 during the ON period, and hold the previously applied voltage during the OFF period. Then, by controlling the light transmission rate of the liquid crystal, which is determined by the T-V characteristic that is an electro-optical characteristic of the liquid crystal, based on the data voltage applied through the TFTs 21, an image is displayed.

The liquid crystal display apparatus of this embodiment comprises peripheral circuits, such as a control signal generating circuit 41, an image memory 42, a first logical product circuit (AND circuit) 46a, a second logical product circuit (AND circuit) 46b, an inverting circuit (INV circuit) 47, an exclusive OR circuit (EX-OR circuit) 48 and a back light power circuit 49 as shown in FIG. 15, in addition to the above-mentioned source driver 22 and gate driver 24.

The control signal generating circuit 41 generates, from an inputted synchronous signal Sync, an image control signal CS for controlling the output timing of an image signal stored in the image memory 42, a write polarity control signal PN for controlling a voltage polarity for writing a data voltage to the pixel electrode 5, an output polarity control signal DM for controlling an output voltage polarity of the source driver 22, a clock signal CLK, etc. for controlling the operation of the source driver 22, an operation clock signal CPV for determining a scanning frequency for controlling the operation of the gate driver 24, and a scanning start signal STV, etc. for determining the scanning start timing. Further, the control signal generating circuit 41 outputs the generated image control signal CS to the image memory 42; outputs the write polarity control signal PN to the exclusive OR circuit 48; outputs the output polarity control signal DM to the exclusive OR circuit 48 and the source driver 22; outputs the clock signal CLK, etc. to the source driver 22; and outputs the operation clock signal CPV and the scanning start signal STV, etc. to the gate driver 24.

The image memory 42 temporarily stores display data Data to be displayed on the liquid crystal panel 1, and outputs data PD1 for display of odd-numbered columns to the first AND circuit 46a and outputs data PD2 for display of even-numbered columns to the second AND circuit 46b alternately in synchronous with the image control signal CS generated by the control signal generating circuit 41.

The exclusive OR circuit 48 is supplied with the write polarity control signal PN and output polarity control signal DM both generated by the control signal generating circuit 41, and outputs the exclusive OR signal of these two signals. The output signal of the exclusive OR circuit 48 functions as an output selection signal for determining whether a data voltage for display or a reset voltage for refresh is to be applied to the pixel electrode 5.

The first AND circuit 46a is a circuit for generating data signals for display and data signals for refresh for odd-numbered columns. More specifically, the first AND circuit 46a generates an AND signal from a signal obtained by inverting the output selection signal generated by the exclusive OR circuit 48 in the inverting circuit 47 and the data PD1 for display of odd-numbered columns read from the image memory 42, and inputs the generated signal PD1a as the data signal DATA to the source driver 22.

The second AND circuit 46b is a circuit for generating data signals for display and data signals for refresh for even-numbered columns. More specifically, the second AND circuit 46b generates an AND signal from the output selection signal generated by the exclusive OR circuit 48 and the data PD2 for display of even-numbered columns read from the image memory 42, and inputs the generated signal PD2a as the data signal DATA to the source driver 22.

The scanning start signal STV, etc. and the operation clock signal CPV generated by the control signal generating circuit 41 are inputted to the gate driver 24.

Note that the source driver 22 is a dot inversion drive type source driver and is the same as that described in the first embodiment, and therefore the detailed explanation thereof is omitted.

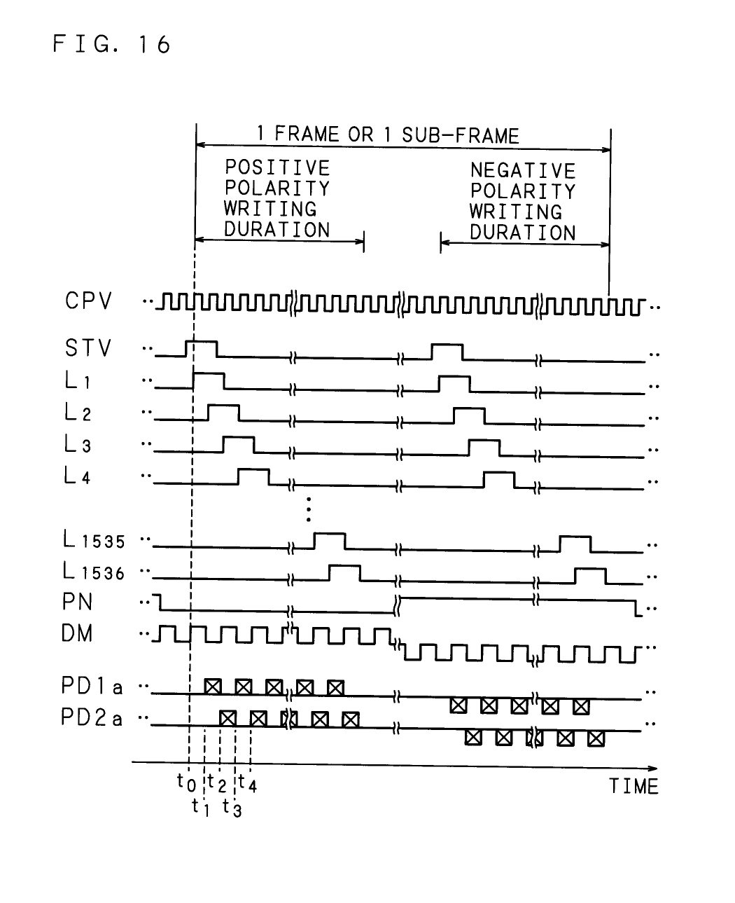

FIG. 16 is a timing chart showing a drive sequence in the second embodiment of the present invention. First, the following description will explain the timing of the scanning line Lₖ. CPV is an operation clock signal of the gate driver 24 for scanning the TFTs 21. STV is a scanning start signal of the gate driver 24, and the width of the “H” period that determines the ON period of the TFT 21 is substantially equal to two clocks of the operation clock signal CPV The STV is inputted substantially ½ clock prior to the rise of the operation clock signal CPV so as to prevent a latching mistake of the gate driver 24.

The gate driver 24 includes a shift register therein. Each output stage of the gate driver 24 obtains a voltage value of an input signal at the rising edge of the operation clock signal CPV, and holds the obtained voltage value at time other than the rising edge. In the gate driver 24, the obtained voltage value is delayed for a predetermined time to make an input signal for the next stage. Thus, based on the scanning start signal STV and the operation clock signal CPV, signals for sequentially scanning the ON periods (“H” periods) are inputted to the scanning lines Lₖ.

If an edge where the operation clock signal CPV rises when the scanning start signal STV is in the “H” state is considered as the first rising edge, a signal to be inputted to the scanning line Lₖ connected to the output stage of the gate driver 24 rises at the k-th rising edge of the operation clock signal CPV, and falls at the (k+2)th rising edge of the same. For example, the scanning line L₁ rises at the first rising edge of the operation clock signal CPV, and falls at the third rising edge of the same. The scanning line L₂ rises at the second rising edge of the operation clock signal CPV, and falls at the fourth rising edge of the same.

Therefore, as the scanning line Lₖ for scanning one row of the TFTs 21 arranged in matrix form, by providing a scanning line for odd-numbered columns and a scanning line for even-numbered columns, the period of turning on the TFT 21 can be made different between the TFTs 21 in the odd-numbered columns and the TFTs 21 in the even-numbered columns in the same row. However, although an overlapped time is present between them, since display gradation is determined by a voltage applied to the pixel through the TFT 21 at the end of the ON period, it is important that the ON periods end at different timings.

Next, the timing of the data scanning line Dⱼ will be explained. A write polarity control signal PN of “L” is inputted in a positive polarity writing duration, while a write polarity control signal PN of “H” is inputted in a negative polarity writing duration. The frequency of the output polarity control signal DM is ½ of the frequency of the operation clock signal CPV of the gate driver 24. The inverted signal of the exclusive OR of the write polarity control signal PN and the output polarity control signal DM is a signal for selecting a write voltage for an odd-numbered column either as a reset voltage for refresh or a data voltage for display. The exclusive OR signal of the write polarity control signal PN and the output polarity control signal DM is a signal for selecting a write voltage for an even-numbered column either as a reset voltage for refresh or a data voltage for display.

The relationship between the combination of the polarities of the write polarity control signal PN and output polarity control signal DM and the output voltage is as shown in Table 3. For example, when the write polarity control signal PN is “L” and the output polarity control signal DM is “L”, a positive data voltage is outputted from the odd-numbered output terminal, and a reset voltage (−0 V) as negative 0 gradation is outputted from the even-numbered output terminal.

TABLE 3

| PN | DM | Odd-numbered | Even-numbered |
|---|---|---|---|
| signal | signal | output terminal | output terminal |
| L | L | Positive data voltage | Negative 0 gradation |
| | | | voltage (−0 V) |
| L | H | Negative 0 gradation | Positive data voltage |
| | | voltage (−0 V) | |
| H | L | Positive 0 gradation | Negative data voltage |
| | | voltage (+0 V) | |
| H | H | Negative data voltage | Positive 0 gradation |
| | | | voltage (+0 V) |

Accordingly, during an ON period of the TFT 21, the reset voltage for refresh is applied to the pixel electrode 5 in the first half of the ON period, while the data voltage for display is applied to the pixel electrode 5 in the second half of the ON period. More specifically, when the write polarity control signal PN is “L”, both of the odd-numbered output terminal and even-numbered output terminal apply a reset voltage (−0 V) as negative 0 gradation to the pixel electrodes 5 in the first half of the ON period, and apply the positive data voltage to the pixel electrodes 5 in the second half of the ON period. When the write polarity control signal PN is “H”, both of the odd-numbered output terminal and even-numbered output terminal apply a reset voltage (+0 V) as positive 0 gradation to the pixel electrodes 5 in the first half of the ON period, and apply the negative data voltage to the pixel electrodes 5 in the second half of the ON period. Note that, by adjusting the duty ratio of the operation clock signals CPV to be substantially 50%, the first half of the ON period and the second half of the ON period can be made substantially equal to each other.

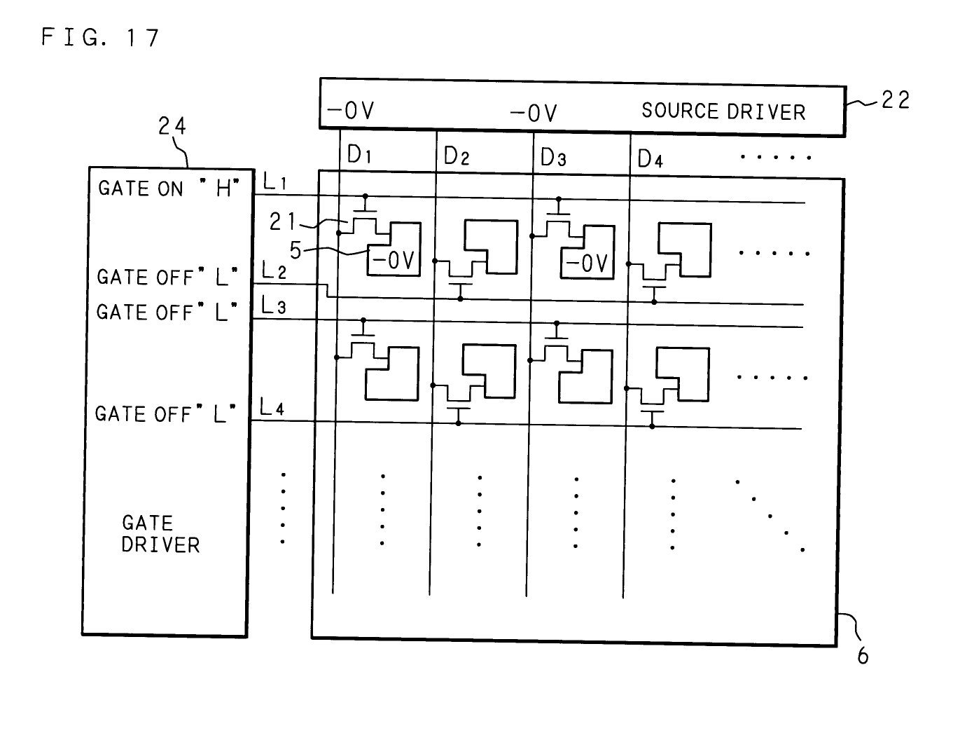

FIG. 17 through FIG. 20 show voltages applied to the pixels in the periods from t0 to t4 of the timing chart of FIG. 16. In the period t0 to t1, since the “H” signal is inputted to the scanning line L₁, the TFTs 21 in the odd-numbered columns in the first row, connected to the scanning line L₁, are turned ON. Consequently, the reset voltage (−0 V) as negative 0 gradation supplied to the respective data lines Dⱼ is supplied to the pixel electrodes 5 (See FIG. 17).

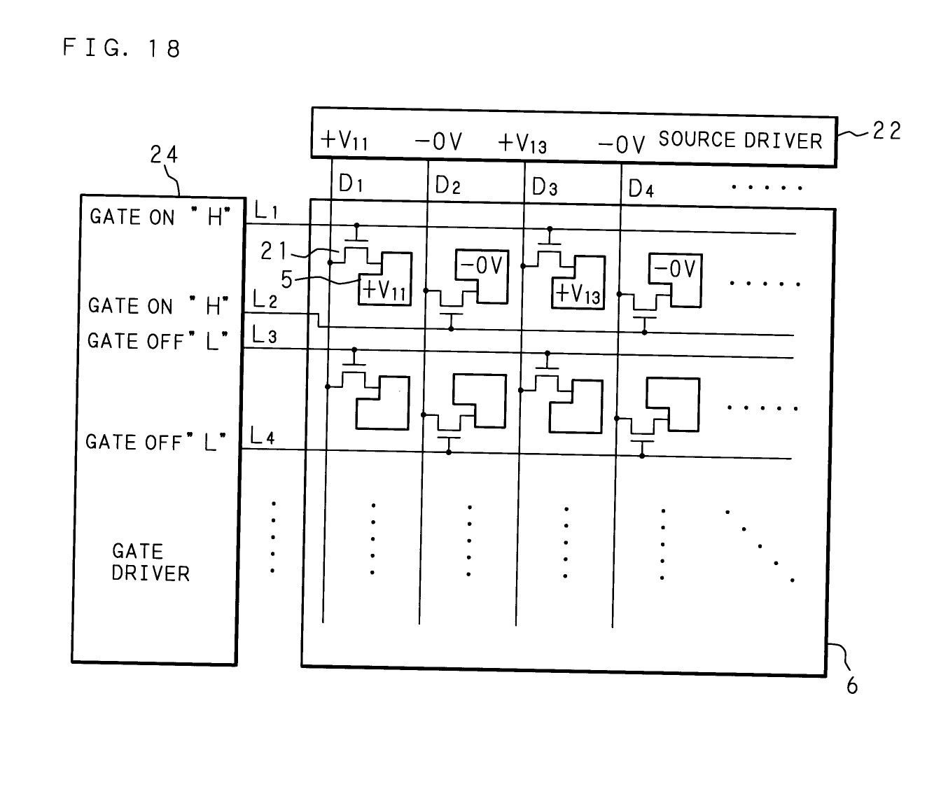

In the period t1 to t2, since the “H” signal is inputted to the scanning lines L₁ and L₂, the TFTs 21 in the odd-numbered columns in the first row, connected to the scanning line L₁, hold the ON state, and the positive data voltages (+V11, +V13, . . . ) supplied to the respective data lines Dⱼ are supplied to the pixel electrodes 5, and then the TFTs 21 in the even-numbered columns in the first row, connected to the scanning line L₂, are turned ON. Consequently, the reset voltage (−0 V) as negative 0 gradation supplied to the respective data lines Dⱼ is supplied to the pixel electrodes 5 (See FIG. 18).

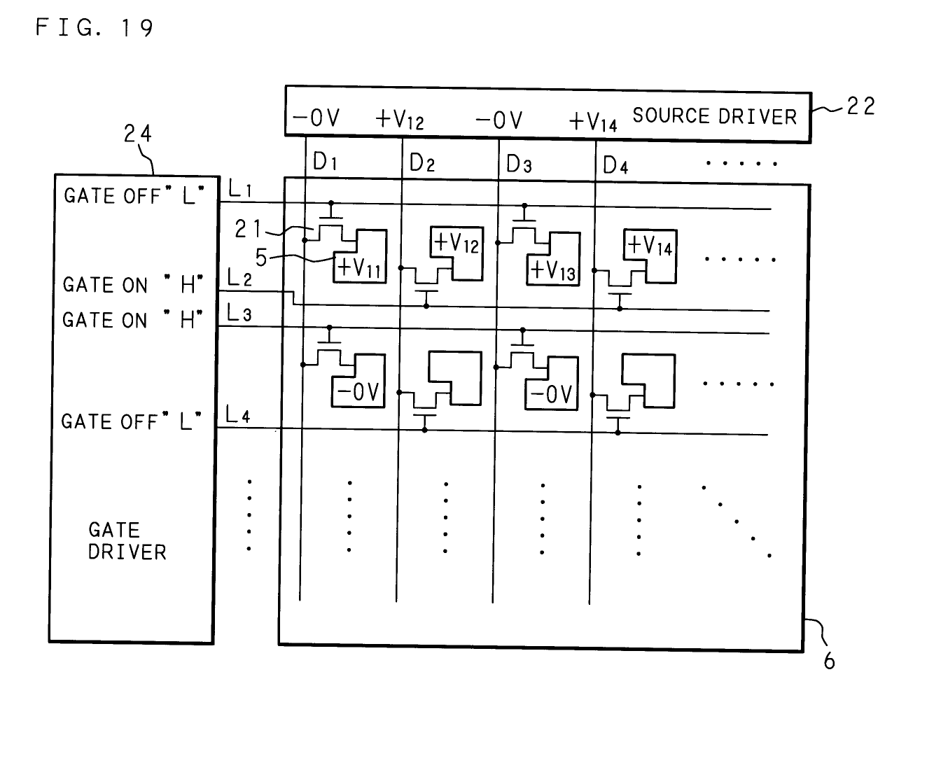

In the period t2 to t3, since the “L” signal is inputted to the scanning line L₁, the TFTs 21 in the odd-numbered columns in the first row, connected to the scanning line L₁, are turned OFF, and hold the positive data voltages (+V11, +V13, . . . ) supplied in the previous period (the t1 to t2 period). Besides, since the “H” signal is inputted to the scanning lines L₂ and L₃, the TFTs 21 in the even-numbered columns in the first row, connected to the scanning line L₂, hold the ON state, and the positive data voltages (+V12, +V14, . . . ) supplied to the respective data lines Dⱼ are supplied to the pixel electrodes 5, and then the TFTs 21 in the odd-numbered columns in the second row, connected to the scanning line L₃, are turned ON. Consequently, the reset voltage (−0 V) as negative 0 gradation supplied to the respective data lines Dⱼ is supplied to the pixel electrodes 5 (See FIG. 19).

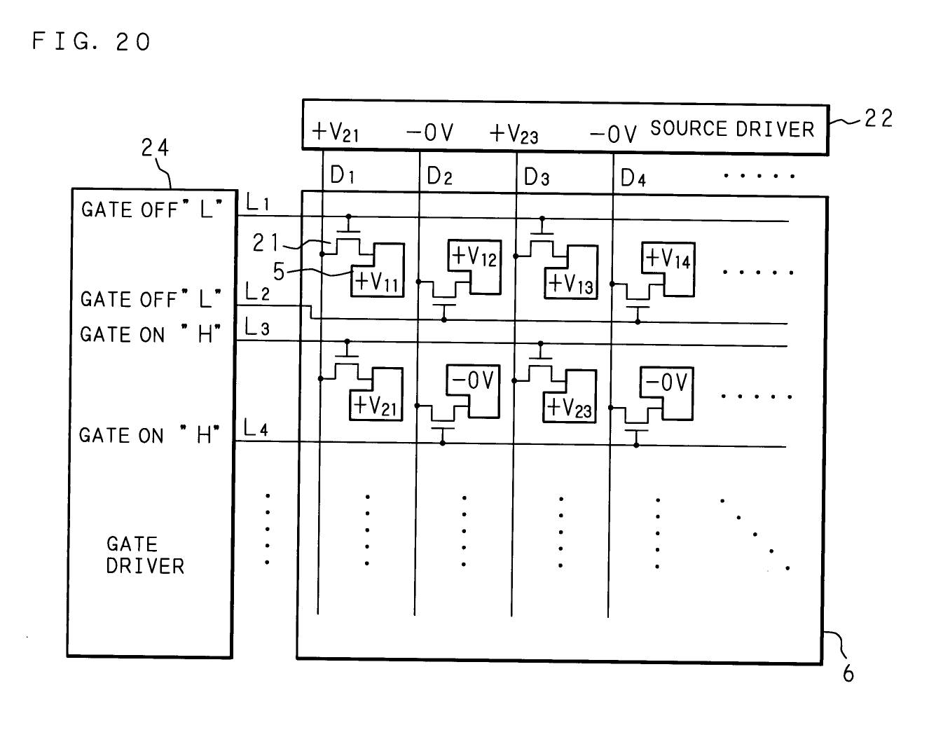

In the period t3 to t4, since the “L” signal is inputted to the scanning line L₂, the TFTs 21 in the even-numbered columns in the first row, connected to the scanning line L₂, are turned OFF, and hold the positive data voltages (+V12, +V14, . . . ) supplied in the previous period (the t2 to t3 period). Besides, since the “H” signal is inputted to the scanning lines L₃ and L₄, the TFTs 21 in the odd-numbered columns in the second row, connected to the scanning line L₃, hold the ON state, and the positive data voltages (+V21, +V23, . . . ) supplied to the respective data lines Dⱼ are supplied to the pixel electrodes 5, and then the TFTs 21 in the even-numbered columns in the second row, connected to the scanning line L₄, are turned ON. Consequently, the reset voltage (−0 V) as negative 0 gradation supplied to the respective data lines Dⱼ is supplied to the pixel electrodes 5 (See FIG. 20).

With this sequence of operations, like the first embodiment, since a reset voltage is applied just before the application of a data voltage, it is possible to apply a predetermined data voltage without depending on the data voltage in the previous frame. Moreover, the voltage polarities applied to the respective pixels have the polarities as shown in FIG. 13, and thus it is possible to display the same polarity.

As shown in FIG. 8 and FIG. 16, a scanning signal of the first embodiment is a two-phase input, while a scanning signal of the second embodiment is a one-phase input. Accordingly, the frequency of the operation clock signal used for the gate driver 24 of the second embodiment needs to be substantially twice that of the two gate drivers 24a, 24b of the first embodiment.

Note that although the above-described embodiments explain frame inversion driving using a dot inversion drive type source driver, the present invention is also applicable to line inversion driving. Moreover, although the above-described embodiments explain the cases where the source driver is of a digital signal input type, it is possible to use an analog signal input type. Furthermore, the peripheral drive circuits such as the gate driver and source driver may be implemented as an on-chip structure by forming the peripheral drive circuits on the TFT substrate.

According to the present invention as described above, before application a data voltage for display to the pixel electrodes, the pixels have a constant voltage temporarily due to the refresh function, and thus the data voltage for display is always written from a fixed state to all pixels (the entire screen). It is therefore possible to reduce the difference in applicable voltage values depending on a pixel voltage value before the application of the voltage and obtain a predetermined light transmission rate, and consequently an excellent gradation display characteristic is obtained.

Moreover, by driving the liquid crystal by an AC drive in which the polarity is inverted between the preceding and following display periods (frames or sub-frames), it is possible to prevent degradation of the liquid crystal material and burning of the liquid crystal panel, and extend the life of the liquid crystal display apparatus.

Furthermore, during an ON period of the switching elements, by arranging the first half period for refresh and the second half period for display to be substantially equal, it becomes possible to utilize the writing ability of the switching elements effectively in the respective periods, and consequently an excellent gradation display characteristic is obtained.

Besides, when displaying moving images (including still images) in which the light transmission rate of the pixels does not need to be changed, since the absolute values of the positive voltage and negative voltage applied to the pixels are substantially equal, it is possible to improve the refreshing efficiency by setting the reset voltage for refresh at 0 V, and consequently an excellent gradation display characteristic is obtained.

In addition, even when a dot inversion drive type source driver is used for a liquid crystal panel using an FLC or AFLC having such a T-V characteristic that the light transmission rate has a single polarity with respect to the applied voltage polarity, it is possible to cause the voltages applied to the respective pixel electrodes in each display frame to have the same polarity. It is therefore possible to prevent check-pattern black display and provide advantageous effects such as high display quality.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A driving method for a liquid crystal display apparatus, including a substrate on which pixel electrodes and switching elements for on/off controlling voltage application to said pixel electrodes are arranged in matrix form; a substrate on which a counter electrode is provided; and a liquid crystal material having a spontaneous polarization sealed in a gap between said substrates, by applying a data voltage across said pixel electrodes and said counter electrode during an ON period of said switching elements and holding the data voltage during an OFF period so as to control a light transmission rate of said liquid crystal material which is determined by the data voltage,
wherein said driving method applies a reset voltage of a constant value in a first half period of said ON period, and applies said data voltage in a second half period of said ON period.

2. The driving method for the liquid crystal display apparatus as set forth in claim 1, wherein said first half period is substantially ½ of said ON period.

3. The driving method for the liquid crystal display apparatus as set forth in claim 1, wherein
said switching elements are on/off controlled at predetermined time intervals,
data voltages of opposite polarities are applied alternately in preceding and following ON periods, and
a reset voltage with a polarity opposite to the data voltage is applied in the same ON period.

4. The driving method for the liquid crystal display apparatus as set forth in claim 3, wherein said reset voltage is 0 V.

5. The driving method for the liquid crystal display apparatus as set forth in claim 3, wherein said first half period is substantially ½ of said ON period.

6. The driving method for the liquid crystal display apparatus as set forth in claim 5, wherein said reset voltage is 0 V.

7. A liquid crystal display apparatus including a substrate on which pixel electrodes and switching elements for on/off controlling voltage application to said pixel electrodes are arranged in matrix form; a substrate on which a counter electrode is provided; and a liquid crystal material having a spontaneous polarization sealed in a gap between said substrates, wherein a data voltage is applied across said pixel electrodes and said counter electrode during an ON period of said switching elements and the data voltage is held during an OFF period so as to control a light transmission rate of said liquid crystal material which is determined by the data voltage, said liquid crystal display apparatus comprising:
means for applying a reset voltage of a predetermined value in a first half period of said ON period; and
means for applying said data voltage in a second half period of said ON period.

8. The liquid crystal display apparatus as set forth in claim 7, wherein
said switching elements are on/off controlled at predetermined time intervals,
said data voltage applied in an ON period has a polarity opposites to data voltages applied in ON periods preceding and following said ON period, and
said reset voltage has a polarity opposite to the data voltage in the same ON period.

9. The liquid crystal display apparatus as set forth in claim 8, wherein said first half period is substantially ½ of said ON period.

10. The liquid crystal display apparatus as set forth in claim 8, further comprising:
a first scanning line connected with the switching elements connected to pixels in odd-numbered matrix columns among pixels in a matrix row, and a second scanning line connected with the switching elements connected to pixels in even-numbered matrix columns in the same matrix row; and
a scanning circuit having a plurality of output portions for on/off controlling said switching elements; wherein
said first scanning line and said second scanning line are alternately connected to the output portions of said scanning circuit.

11. The liquid crystal display apparatus as set forth in claim 10, further comprising a control circuit for controlling scanning of said scanning circuit, wherein
said scanning circuit comprises:
means for generating an operation clock signal for determining a scanning frequency of said scanning circuit; and
means for generating a scanning start signal, having a signal width equal to a two-clock period of said operation clock signal, for determining scanning start timing of said scanning circuit and said ON period.

12. The liquid crystal display apparatus as set forth in claim 7, wherein said first half period is substantially ½ of said ON period.

13. The liquid crystal display apparatus as set forth in claim 12, further comprising:
a first scanning line connected with the switching elements connected to pixels in odd-numbered matrix columns among pixels in a matrix row, and a second scanning line connected with the switching elements connected to pixels in even-numbered matrix columns in the same matrix row; and
a scanning circuit having a plurality of output portions for on/off controlling said switching elements; wherein
said first scanning line and said second scanning line are alternately connected to the output portions of said scanning circuit.

14. The liquid crystal display apparatus as set forth in claim 13, further comprising a control circuit for controlling scanning of said scanning circuit, wherein
said scanning circuit comprises:
means for generating an operation clock signal for determining a scanning frequency of said scanning circuit; and
means for generating a scanning start signal, having a signal width equal to a two-clock period of said operation clock signal, for determining scanning start timing of said scanning circuit and said ON period.

15. The liquid crystal display apparatus as set forth in claim 7, wherein said reset voltage is 0 V.

16. The liquid crystal display apparatus as set forth in claim 15, further comprising:
a first scanning line connected with the switching elements connected to pixels in odd-numbered matrix columns among pixels in a matrix row, and a second scanning line connected with the switching elements connected to pixels in even-numbered matrix columns in the same matrix row; and
a scanning circuit having a plurality of output portions for on/off controlling said switching elements; wherein
said first scanning line and said second scanning line are alternately connected to the output portions of said scanning circuit.

17. The liquid crystal display apparatus as set forth in claim 16, further comprising a control circuit for controlling scanning of said scanning circuit, wherein
said scanning circuit comprises:
means for generating an operation clock signal for determining a scanning frequency of said scanning circuit; and
means for generating a scanning start signal, having a signal width equal to a two-clock period of said operation clock signal, for determining scanning start timing of said scanning circuit and said ON period.

18. The liquid crystal display apparatus as set forth in claim 7, further comprising:
a first scanning line connected with the switching elements connected to pixels in odd-numbered matrix columns among pixels in a matrix row, and a second scanning line connected with the switching elements connected to pixels in even-numbered matrix columns in the same matrix row;
a first scanning circuit and second scanning circuit having a plurality of output portions for on/off controlling said switching elements; and
a control circuit for controlling scanning of said first scanning circuit and second scanning circuit; wherein
said first scanning line and second scanning line are connected to the output portions of said first scanning circuit and second scanning circuit, respectively, and
said control circuit comprises:
means for generating operation clock signals for determining scanning frequencies of said first scanning circuit and second scanning circuit so that polarities have a complementary relationship; and
means for generating a common scanning start signal for determining scanning start timing of said first scanning circuit and second scanning circuit and said ON period.

19. The liquid crystal display apparatus as set forth in claim 7, further comprising:
a first scanning line connected with the switching elements connected to pixels in odd-numbered matrix columns among pixels in a matrix row, and a second scanning line connected with the switching elements connected to pixels in even-numbered matrix columns in the same matrix row; and
a scanning circuit having a plurality of output portions for on/off controlling said switching elements; wherein
said first scanning line and said second scanning line are alternately connected to the output portions of said scanning circuit.

20. The liquid crystal display apparatus as set forth in claim 19, further comprising a control circuit for controlling scanning of said scanning circuit, wherein
said scanning circuit comprises:
means for generating an operation clock signal for determining a scanning frequency of said scanning circuit; and
means for generating a scanning start signal, having a signal width equal to a two-clock period of said operation clock signal, for determining scanning start timing of said scanning circuit and said ON period.
